(19) United States
(12) Patent Application Publication
(10) Pub. No.: US 2021/0179374 A1
(43) Pub. Date: Jun. 17, 2021

(54) IMAGE READING DEVICE AND STAPLE DETERMINATION METHOD

(71) Applicant: PANASONIC INTELLECTUAL PROPERTY MANAGEMENT CO., LTD., Osaka (JP)

(72) Inventors: Hidetoshi IKEDA, Fukuoka (JP); Terumi TSUDA, Fukuoka (JP); Genki TOKUNAGA, Osaka (JP); Hiroshi KUSUDA, Fukuoka (JP); Takefusa OGATA, Fukuoka (JP); Tadashi YAMAGUCHI, Fukuoka (JP); Hirotsugu FUSAYASU, Kyoto (JP); Takeshi MATSUMOTO, Shiga (JP)

(73) Assignee: PANASONIC INTELLECTUAL PROPERTY MANAGEMENT CO., LTD., Osaka (JP)

(21) Appl. No.: 16/076,229

(22) PCT Filed: Aug. 29, 2016
(86) PCT No.: PCT/JP2016/003925

§ 371 Date: Aug. 7, 2018

(30) Foreign Application Priority Data
Feb. 17, 2016 (JP) 2016-028104
Feb. 17, 2016 (JP) 2016-028107
Feb. 17, 2016 (JP) 2016-028110

(51) Int. Cl. B65H 7/02; B65H 37/04; H04N 1/00

(52) U.S. Cl. CPC B65H 7/02; B65H 37/04; H04N 1/00721; H04N 1/00814; H04N 1/00037; H04N 1/00013; H04N 1/00809; H04N 1/00639

(57) ABSTRACT

An image reading device includes: a document delivery unit for delivering a document loaded on a document loading platform to a document transport path; a flip-up detector for detecting flip-up of the document when the document is delivered; a metal detector for detecting metal attached to the document when the document is delivered; and a staple determination unit for determining whether or not a stapling process is applied to the document based on detection results of the flip-up detector and the metal detector.

### TECHNICAL FIELD

This disclosure relates to an image reading device and a staple determination method

### BACKGROUND ART

An image reading device, in which a document loaded on a document loading platform (paper feeding tray) is transported one by one to a document transport path, an image formed on the document is read by an image reader disposed in the document transport path, and then the document is discharged to a document discharging unit (paper discharging tray), is known.

A binding process (stapling process) of a staple or the like is executed in the document loaded on the document loading platform of the image reading device. In a case where a bound bundle (document bundle) of documents is transported by a document transport path, the document is torn, or a transport roller and the image reader disposed on the document transport path are damaged.

Therefore, in response to the problem, a technique, in which staple detecting means (for example, a magnetic sensor) for detecting a staple applied to the document loaded on the document loading platform is provided to determine whether or not the stapling process is applied to the document, is proposed (for example, see PTL 1).

However, in the document, there are various places to which the stapling process is applied and it is not necessarily always stapled at a disposition position of the staple detecting means. That is, even in the document to which the stapling process is applied, if the staple detecting means is not disposed at a position at which stapling can be detected, presence or absence of the stapling process with respect to the document cannot be determined.

A main object of this disclosure is to determine presence or absence of a stapling process with high accuracy.

### CITATION LIST

### Patent Literature

PTL 1: Japanese Patent Unexamined Publication No. 10-239920

### SUMMARY OF THE INVENTION

An image reading device of the disclosure transports a document loaded on a document loading platform to a document transport path and reads an image formed on the document. The image reading device of this disclosure includes: a document delivery unit for delivering the document loaded on the document loading platform to the document transport path; a flip-up detector for detecting flip-up of the document when the document is delivered by the document delivery unit; an abnormal sound detector for detecting occurrence of abnormal sound when the document is delivered by the document delivery unit; a double feeding detector for detecting double-feeding of the document when the document is delivered by the document delivery unit; and a staple determination unit for determining whether or not a stapling process is applied to the document based on detection results of the flip-up detector, the abnormal sound detector, and the double feeding detector.

A staple determination method of this disclosure includes: acquiring a detection result of a flip-up detector that detects flip-up of a document when the document loaded on a document loading platform is delivered to a document transport path; acquiring a detection result of an abnormal sound detector that detects occurrence of abnormal sound when the document is delivered; acquiring a detection result of a double feeding detector that detects double-feeding of the document when the document is delivered; and determining whether or not a stapling process is applied to the document based on detection results of the flip-up detector, the abnormal sound detector, and the double feeding detector.

According to this disclosure, presence or absence of the stapling process can be determined with high accuracy.

### BRIEF DESCRIPTION OF DRAWINGS

FIG. 1 is a perspective view of an entirety of an image reading device in an embodiment.

FIG. 2 is a block diagram illustrating a function configuration of the image reading device in the embodiment.

FIG. 3 is a side sectional view of the image reading device in the embodiment.

FIG. 4 is an upper sectional view of the image reading device in the embodiment.

FIG. 5 is a view for explaining a position at which a stapling process is applied to a document.

FIG. 6 is a view illustrating a manner of detecting flip-up of the document.

FIG. 7 is a view illustrating a manner of detecting occurrence of abnormal sound.

FIG. 8 is a view illustrating a manner of detecting double-feeding of the document.

FIG. 9 is a view illustrating a manner of detecting metal attached to the document.

FIG. 10 is a view illustrating whether or not each detector detects a position to which the stapling process is applied.

FIG. 11 is a view illustrating whether or not each detector detects a position to which the stapling process is applied.

FIG. 12 is a flowchart illustrating a staple determining operation of the image reading device in the embodiment.

FIG. 13 is a view illustrating whether or not each detector detects a position to which the stapling process is applied.

FIG. 14 is a view illustrating whether or not each detector detects a position to which the stapling process is applied.

FIG. 15 is a flowchart illustrating a staple determining operation of the image reading device in the embodiment.

FIG. 16 is a view illustrating whether or not each detector detects a position to which the stapling process is applied.

FIG. 17 is a flowchart illustrating a staple determining operation of the image reading device in the embodiment.

### DESCRIPTION OF EMBODIMENTS

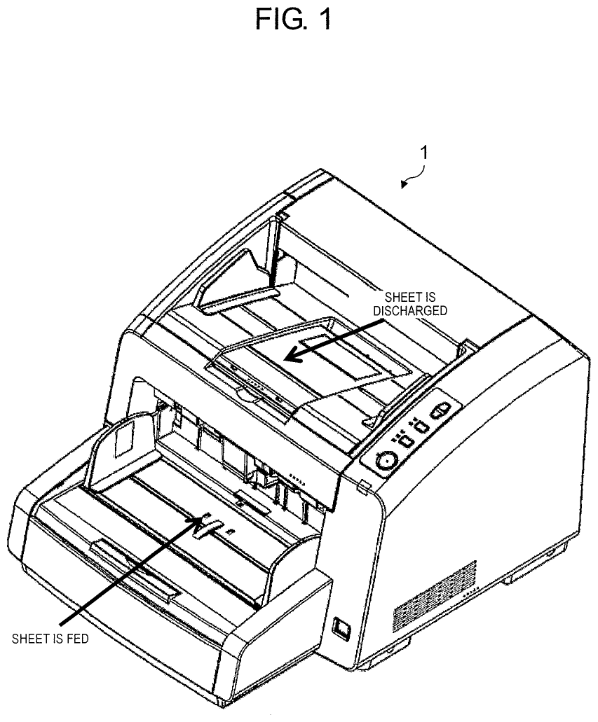

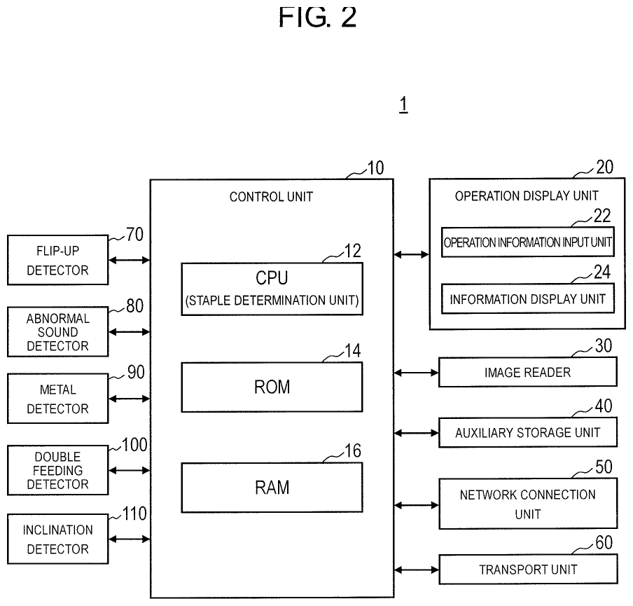

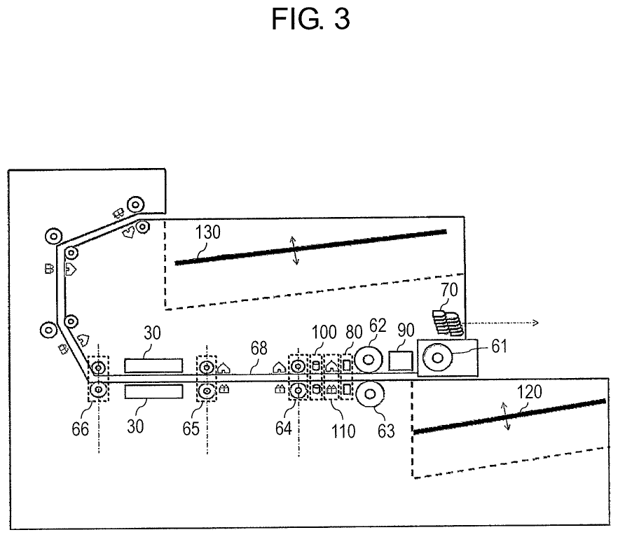

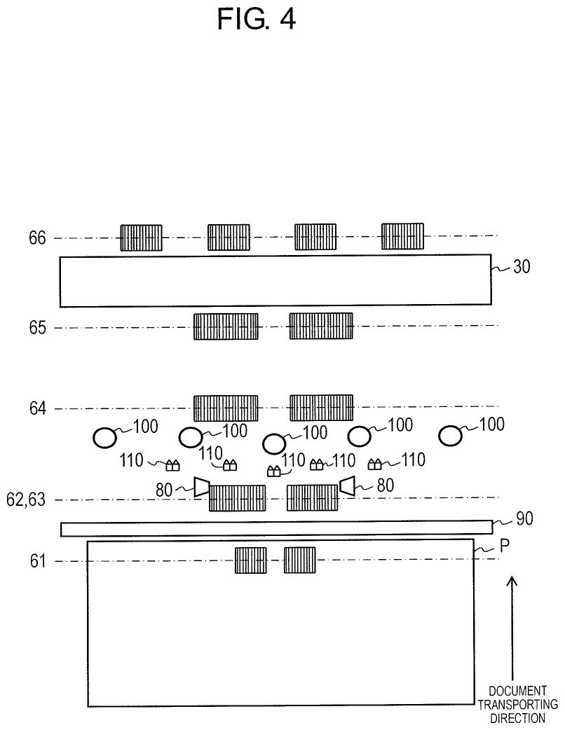

Hereinafter, an embodiment will be described with reference to the drawings. FIG. 1 is a perspective view of an entirety of image reading device 1 in the embodiment as viewed from front and above the device. FIG. 2 is a block diagram illustrating a function configuration of image reading device 1. FIG. 3 is a side sectional view of image reading device 1. FIG. 4 is an upper sectional view of image reading device 1.

Image reading device 1 is a document scanner and transports (feeds) a document loaded on document loading platform 120 one by one to document transport path 68, reads an image formed on the document in image reader 30 disposed on document transport path 68, and then discharges (ejects) the document to document discharging unit 130. Moreover, image reading device 1 may be applied to an electrophotographic image forming apparatus.

As illustrated in FIG. 2, image reading device 1 includes control unit 10, operation display unit 20, image reader 30, auxiliary storage unit 40, network connection unit 50, transport unit 60, flip-up detector 70, abnormal sound detector 80, metal detector 90, double feeding detector 100, and inclination detector 110.

Control unit 10 includes Central Processing Unit (CPU) 12 and operation memories such as Read Only Memory (ROM) 14 for storing a control program (corresponding to a “staple determining program” of this disclosure) and Random Access Memory (RAM) 16. CPU 12 reads a control program from ROM 14, develops the control program in RAM 16, and centrally controls an operation of each block or the like of image reading device 1 in cooperation with the developed control program. In this case, various data stored in auxiliary storage unit 40 are referred. Auxiliary storage unit 40 is configured of, for example, nonvolatile semiconductor memory (so-called flash memory) or a hard disk drive. Control unit 10 functions as a “staple determination unit” and a “transport controller” of this disclosure.

Control unit 10 transmits and receives various data to and from an external device (for example, a personal computer) connected to a communication network such as a Local Area Network (LAN) or a Wide Area Network (WAN) via network connection unit 50. Control unit 10 transmits an image read by image reader 30 to the external device (for example, the personal computer). Network connection unit 50 is configured of, for example, a communication control card such as a LAN card.

Image reader 30 optically reads an image formed on the document transported in document transport path 68, photoelectrically converts the image, and outputs the image to control unit 10 as image data. Specifically, image reader 30 irradiates light from an exposure lamp onto the document, receives reflected light on a receiving surface of a solid-state imaging device such as a Charge Coupled Device (CCD) via an imaging lens to perform photoelectric conversion. In the embodiment, image reader 30 can collectively read images formed on both surfaces (front surface and back surface) of the document.

Operation display unit 20 functions as operation information input unit 22 and information display unit 24. Operation information input unit 22 includes various operation keys such as ten keys and a start key, accepts various input operations by a user, and outputs an operation signal to control unit 10. Information display unit 24 displays various operation screens, an operation status of each function, and the like according to a display control signal input from control unit 10.

Transport unit 60 includes document transport path 68, document loading platform 120, document discharging unit 130, and the like. Transport unit 60 has a plurality of transport rollers for transporting the document on document transport path 68. Document loading platform 120 and document discharging unit 130 are configured to be capable of moving up and down according to the number of loaded documents.

As illustrated in FIGS. 3 and 4, paper feeding roller 61, metal detector 90, separation and retard rollers 62 and 63, abnormal sound detector 80, inclination detector 110, double feeding detector 100, first transport roller pair 64, second transport roller pair 65, image reader 30, and third transport roller pair 66 are disposed on document transport path 68 from an upstream side in a document transporting direction.

The document loaded on document loading platform 120 is drawn into between separation roller 62 and retard roller 63 by paper feeding roller 61. The documents drawn in between separation roller 62 and retard roller 63 are separated one by one and sent, and are transported to first transport roller pair 64. Furthermore, the document is transported to image reader 30 at a constant speed by first and second transport roller pairs 64 and 65. Images formed on the front surface and the back surface of the document are read in image reader 30. Thereafter, the document is discharged to document discharging unit 130 by third transport roller pair 66, a paper discharge roller pair, and the like. Moreover, separation roller 62 and retard roller 63 function as a “document delivery unit” of this disclosure.

Meanwhile, a stapling process is applied to the document loaded on document loading platform 120 of image reading device 1. In general, the stapling process is a process of stitching a plurality of documents of binding objects using a binding needle (staple needle) made of metal or nonmetal to bind the plurality of the documents with the staple needle itself. In the embodiment, the stapling process also includes a process of crimping and binding the plurality of the documents without stitching the plurality of the documents as the binding targets using the staple needle. In a case where a bundle (document bundle) of the documents which are bound as described above is transported by document transport path 68, there is a problem that the document itself is torn, or transport roller pairs 64, 65, and 66, and image reader 30 disposed on document transport path 68 are damaged.

Therefore, in the embodiment, as stapling process detecting means for detecting the stapling process applied to the document loaded on document loading platform 120, image reading device 1 includes flip-up detector 70, abnormal sound detector 80, metal detector 90, double feeding detector 100, and inclination detector 110. Control unit 10 determines whether or not the stapling process is applied to the document based on detection results of flip-up detector 70, abnormal sound detector 80, metal detector 90, double feeding detector 100, and inclination detector 110. In a case where control unit 10 determines that the stapling process is applied to the document, control unit 10 controls transport unit 60 so as to stop a transport operation of the document.

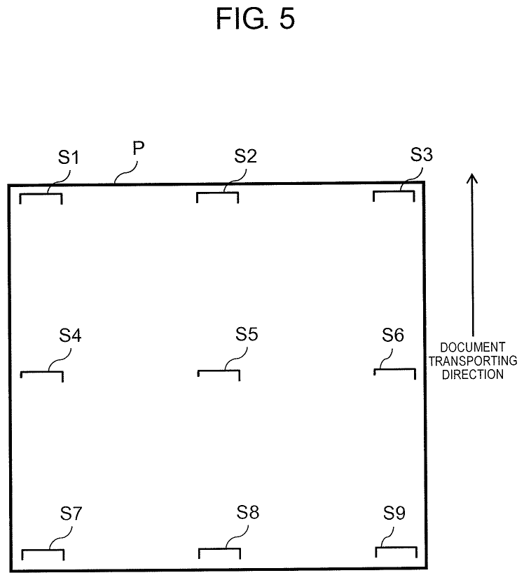

FIG. 5 is a view for explaining an example of a position at which the stapling process is applied to document P. As illustrated in FIG. 5, positions at which the stapling process is applied to document P include S1 to S3 of a leading end portion, S4 to S6 of a center portion, and S7 to S9 of a trailing end portion of document P in the document transporting direction.

Next, a configuration of flip-up detector 70 will be described. As illustrated in FIG. 3, flip-up detector 70 is an ultrasonic sensor provided above paper feeding roller 61 and detects flip-up of document P when document P is delivered by separation roller 62 and retard roller 63.

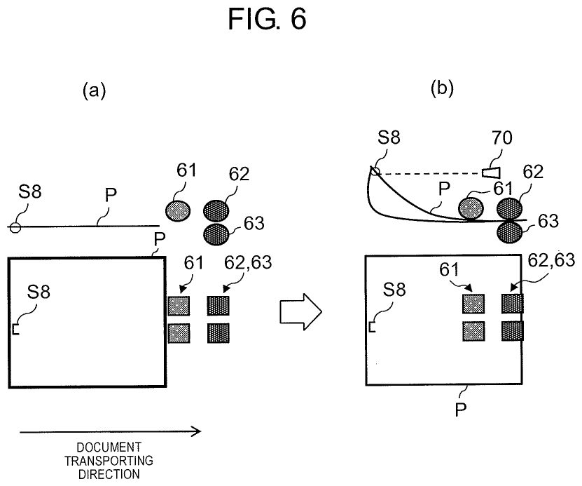

FIG. 6 is a view illustrating a manner of detecting flip-up of the document. In FIG. 6, (a) illustrates a manner before the plurality of documents P loaded on document loading platform 120 are drawn into between separation roller 62 and retard roller 63 by paper feeding roller 61. In the example illustrated in (a), the stapling process is applied to position S8 of the trailing end portion of document P in the document transporting direction.

In FIG. 6, (b) illustrates a manner when documents P drawn into between separation roller 62 and retard roller 63 are separated and delivered one by one. In this case, first document P is fed by separation roller 62 and second and subsequent documents P are blocked to be fed by retard roller 63. As a result, first document P flips up (rises). Flip-up detector 70 normally transmits an ultrasonic pulse in a direction opposite to the document transporting direction and in a case where first document P flips up, for example, equal to a predetermined height or more, receives a reflected wave reflected by document P, detects flip-up of document P from the received reflected wave, and outputs the fact to control unit 10. That is, flip-up detector 70 directly detects that the stapling process is applied to document P.

If the stapling process is applied to positions S4 to S6 of the center portion and positions S7 to S9 of the trailing end portion of document P in the document transporting direction, first document P flips up, so that the flip-up can be detected by flip-up detector 70. Moreover, flip-up detector 70 is not limited to the ultrasonic sensor, but may be an infrared photosensor, or a touch sensor provided at a position capable of coming into contact with document P in a case where document P flips up.

Next, a configuration of abnormal sound detector 80 will be described. Abnormal sound detector 80 detects occurrence of abnormal sound when document P is delivered by separation roller 62 and retard roller 63. Specifically, abnormal sound detector 80 constantly inputs sound generated around abnormal sound detector 80, calculates a time-series variation in a specific frequency region of a sound signal, and compares the calculated time-series variation with a time-series variation (profile) in the specific frequency region of an abnormal sound signal which is created in advance, thereby detecting whether or not there is the abnormal sound.

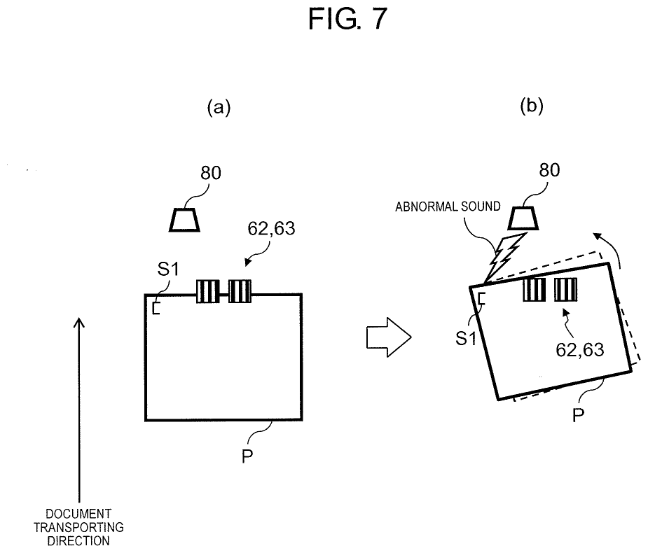

FIG. 7 is a view illustrating a manner of detecting occurrence of the abnormal sound. In FIG. 7, (a) illustrates a manner in which the plurality of documents P loaded on document loading platform 120 are drawn into between separation roller 62 and retard roller 63 by paper feeding roller 61. In the example illustrated in (a), the stapling process is applied to position S1 of the tip portion of document P in the document transporting direction.

In FIG. 7, (b) illustrates a manner when documents P drawn into between separation roller 62 and retard roller 63 are separated and delivered one by one. In this case, only first document P rotates in the counterclockwise direction around position S1 of the tip portion of document P as a rotation fulcrum in (b). As a result, paper breakage or tearing occurring in first document P, or the abnormal sound due to rubbing between first document P and second document P occurs. Abnormal sound detector 80 detects the generated abnormal sound and outputs the fact to control unit 10. In a case where the stapling process is applied to position S3 of the tip portion of document P, only first document P rotates in the clockwise direction around position S3 as the rotation fulcrum in (b). As a result, paper breakage or tearing occurring in first document P, or the abnormal sound due to rubbing between first document P and second document P occurs. That is, if the stapling process is applied to position S1 or S3 of the tip portion of document P, the abnormal sound occurs and the abnormal sound can be detected by abnormal sound detector 80. As described above abnormal sound detector 80 directly detects that the stapling process is applied to document P.

It may detect more accurately that the stapling process is applied to position S1 or S3 of the tip portion of document P by using inclination detector 110 together with abnormal sound detector 80. Inclination detector 110 detects an inclination (for example, an inclination equal to a predetermined angle or more) in the document transporting direction of document P when document P is delivered by separation roller 62 and retard roller 63. Inclination detector 110 is configured to include a plurality of sensors which are disposed, for example, in a document width direction orthogonal to in the document transporting direction and detect a passage of document P. Inclination detector 110 detects the inclination of document P based on a timing detected by each sensor through which transported document P passes. In a case where the stapling process is applied to position S1 or S3 of the tip portion of document P, inclination detector 110 directly detects that document P drawn into between separation roller 62 and retard roller 63 rotates rather than through the occurrence of the abnormal sound.

Next, a configuration of double feeding detector 100 will be described. Double feeding detector 100 is, for example, an ultrasonic sensor disposed on the downstream side of separation roller 62 and retard roller 63 in the document transporting direction, and detects double-feeding (state where plurality of documents P are stacked and transported) of document P when document P is delivered by separation roller 62 and retard roller 63. Double feeding detector 100 may be a laser reader.

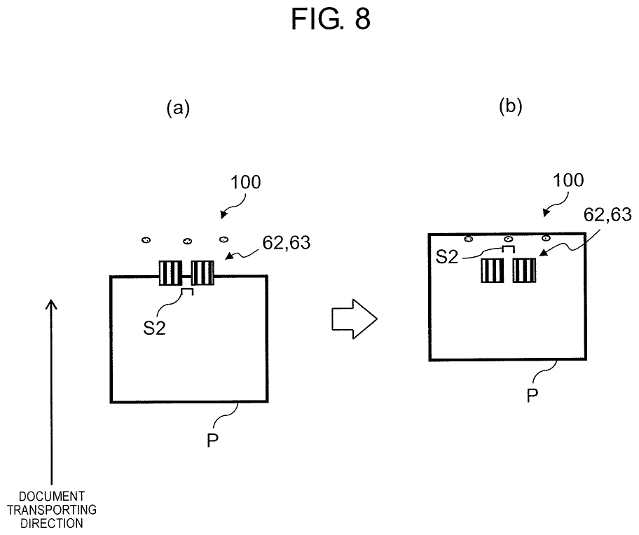

FIG. 8 is a view illustrating a manner of detecting double-feeding of the document. In FIG. 8. (a) illustrates a manner in which the plurality of documents P loaded on document loading platform 120 are drawn into between separation roller 62 and retard roller 63 by paper feeding roller 61. In the example illustrated in (a), the stapling process is applied to position S2 of the tip portion of document P in the document transporting direction. The stapling process may be applied to positions S1 and S3 of the tip portion of document P.

In FIG. 8, (b) illustrates a manner that the plurality of documents P drawn into between separation roller 62 and retard roller 63 are delivered without separation. Double feeding detector 100 includes a transmission portion and a reception portion facing each other via document transport path 68, and detects whether or not documents P are double-fed according to a reception intensity of the reception portion with respect to an ultrasonic pulse normally transmitted from the transmission portion. In a case where document P does not exist between the transmission portion and the reception portion, the ultrasonic pulse hardly attenuates and reaches the reception portion (reception intensity is the maximum). In a case where one document P exists, the ultrasonic pulse is absorbed by document P and an attenuated reception intensity is obtained. As illustrated in (b), in a case where the plurality of documents P to which the stapling process is applied exist (that is, the plurality of documents P are stacked and transported), the ultrasonic pulse transmitted from the transmission portion is absorbed more greatly and a plurality of times of reflection occur between the documents, so that vibration energy is greatly canceled and the reception intensity is remarkably attenuated. As described above, when the ultrasonic pulse transmitted from the transmission portion is received by the reception portion, in a case where a signal intensity of the ultrasonic pulse is greatly attenuated, double feeding detector 100 directly detects that the stapling process is applied to document P. A threshold of the reception intensity for detecting whether or not documents P are double-fed may be arbitrary set by the user.

In a case where the stapling process is applied to position S1 or S3 of document P, only the uppermost one of the plurality of documents P passes through separation roller 62 and retard roller 63 and second and subsequent documents P are held by retard roller 63, so that breakage of document P (first) occurs due to rotational misalignment. In this case, double feeding detector 100 cannot detect that the stapling process is applied to document P. In a case where the stapling process is applied to position S4, S6, S7, or S9 of document P, only the uppermost one of the plurality of documents P passes through separation roller 62 and retard roller 63 and second and subsequent documents P are held by retard roller 63, so that breakage of document P (first) occurs due to flip-up and turning from a side portion. Also in this case, double feeding detector 100 cannot detect that the stapling process is applied to document P. In a case where the stapling process is applied to position S5 or S8 of document P, only the uppermost one of the plurality of documents P passes through separation roller 62 and retard roller 63 and second and subsequent documents P are held by retard roller 63, so that breakage of document P (first) occurs due to flip-up and turning from a center portion. Also in this case, double feeding detector 100 cannot detect that the stapling process is applied to document P.

That is, in a case where the stapling process is applied to position S2 or both positions S1 and S3 of document P, double feeding detector 100 can detect that the stapling process is applied to document P.

Next, a configuration of metal detector 90 will be described. As illustrated in FIG. 3, metal detector 90 is disposed on the upstream side of separation roller 62 and retard roller 63 in the document transporting direction, and when document P is delivered by separation roller 62 and retard roller 63, metal detector 90 detects metal (for example, the staple needle) attached to document P. Metal detector 90 uses, for example, electromagnetic induction and detects the metal by detecting a magnetic field associated with an eddy current generated when the metal passes through a detection coil. Metal detector 90 may detect the metal without using electromagnetic induction.

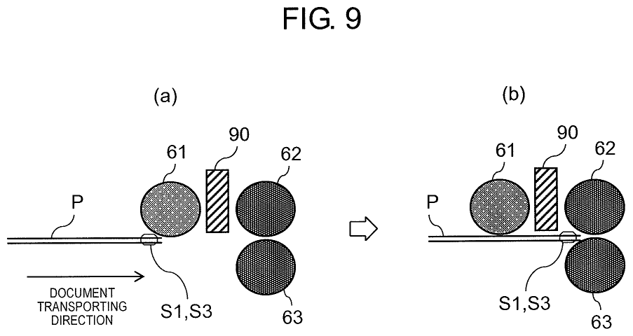

FIG. 9 is a view illustrating a manner of detecting metal attached to the document. In FIG. 9, (a) illustrates a manner before the plurality of documents P loaded on document loading platform 120 are drawn into between separation roller 62 and retard roller 63 by paper feeding roller 61. In the example illustrated in (a), the stapling process is applied to positions S1 and S3 of the tip portion of document P in the document transporting direction, and the staple needle (metal) is attached to document P.

In FIG. 9, (b) illustrates a manner that before document P is drawn into between separation roller 62 and retard roller 63, the staple needles attached to positions S1 and S3 of the tip portion of document P are detected by metal detector 90. In this case, before the plurality of documents P are drawn into between separation roller 62 and retard roller 63, it is possible to early and directly detect that the metal is attached to document P and the stapling process is applied to document P compared to a case where the staple needles are attached to the center portion and the trailing end portion of document P in the document transporting direction.

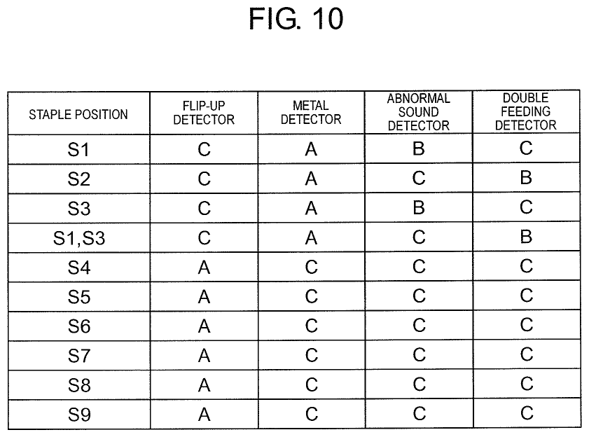

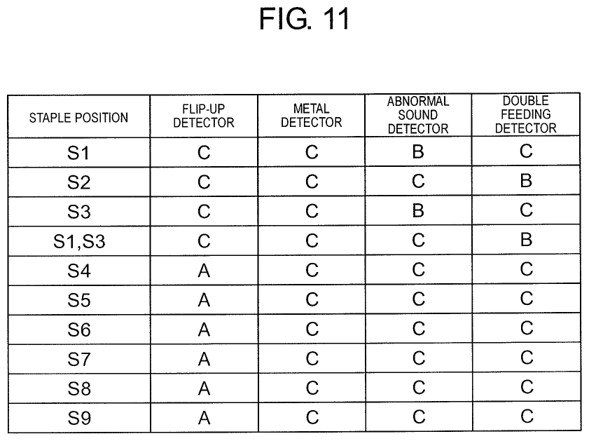

FIGS. 10 and 11 are views illustrating a relationship between each of positions S1 to S9 to which the stapling process is applied in document P, and whether or not the stapling process is detected by each of the detectors (flip-up detector 70, metal detector 90, abnormal sound detector 80, and double feeding detector 100). FIG. 10 illustrates a case where as the stapling process, a process of stitching the plurality of documents P of binding objects is applied using the staple needle made of metal to bind the plurality of documents P with the staple needle itself. FIG. 11 illustrates a case where as the stapling process, a process of stitching the plurality of documents P of binding objects is applied using the staple needle made of nonmetal to bind the plurality of documents P with the staple needle itself, or a process of crimping and binding the plurality of documents P without stitching the plurality of documents P as the binding targets is applied using the staple needle.

In FIGS. 10 and 11, “A” indicates that the stapling process can be detected before the position to which the stapling process is applied passes through separation roller 62 and retard roller 63, that is, the stapling process is early detected. In addition, “B” indicates that the stapling process can be detected before the position to which the stapling process is applied reaches image reader 30 after the position to which the stapling process is applied passes through separation roller 62 and retard roller 63. In addition, “C” indicates that document P itself is torn or transport roller pairs 64 to 66 and image reader 30 disposed on document transport path 68 are broken regardless of whether or not the stapling process is detected by each detector, in a case where only each of the detectors (flip-up detector 70, metal detector 90, abnormal sound detector 80, and double feeding detector 100) is provided.

For example, as illustrated in FIGS. 10 and 11, when the positions to which the stapling process is applied are S1 to S3, the stapling process cannot be detected by flip-up detector 70, but the stapling process can be detected by at least one of metal detector 90, abnormal sound detector 80, and double feeding detector 100 without causing tearing of document P and breakage of transport roller pairs 64 to 66 and image reader 30. Therefore, even if the position to which the stapling process is applied varies in document P, it is possible to accurately determine presence or absence of the stapling process with respect to document P.

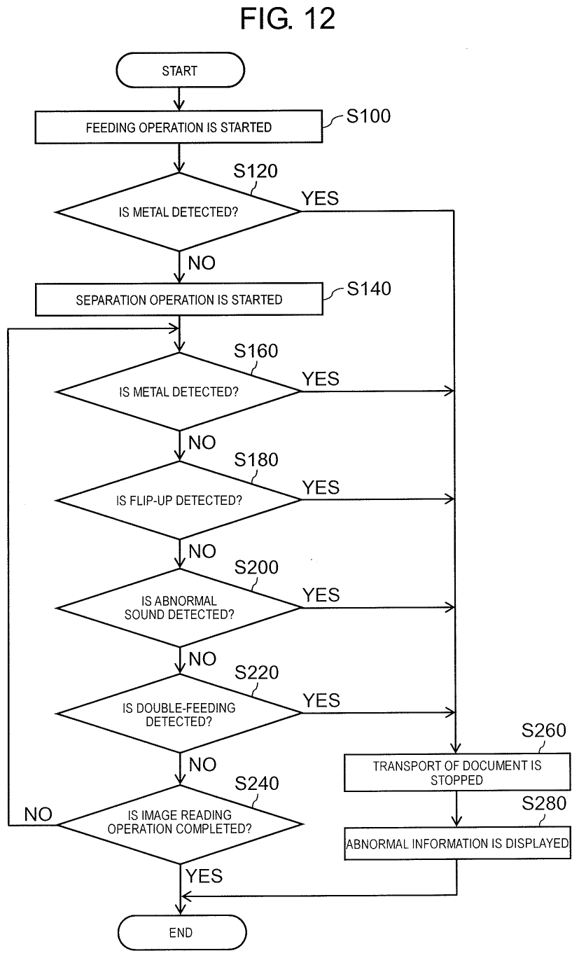

FIG. 12 is a flowchart illustrating a staple determining operation of image reading device 1 in the embodiment. A process of step S100 in FIG. 12 is started when power supply of image reading device 1 is turned on and document P is loaded on document loading platform 120.

First, control unit 10 controls transport unit 60 (paper feeding roller 61) and starts a feeding operation of document P loaded on document loading platform 120 (step S100). Next, control unit 10 acquires a detection result of metal detector 90 and determines whether or not metal is attached to document P and whether or not the stapling process is applied to document P (step S120). As a result of the determination, in a case where the metal is attached (step S120, YES), control unit 10 controls transport unit 60 so as to stop the transport of document P (step S260).

Next, control unit 10 causes information display unit 24 to display abnormal information, more specifically, information indicating the fact that the stapling process is applied to document. P (step S280). Upon completion of the process of step S280, image reading device 1 completes the process in FIG. 12.

Returning to the determination of step S120, in a case where metal is not attached (step S120, NO), control unit 10 controls transport unit 60 (separation roller 62 and retard roller 63) and starts a separation operation of documents P drawn into between separation roller 62 and retard roller 63 by paper feeding roller 61 (step S140).

Next, control unit 10 acquires a detection result of metal detector 90 and determines whether or not metal is attached to document P and whether or not the stapling process is applied to document P (step S160). As a result of the determination, in a case where the metal is attached (step S160, YES), the process proceeds to step S260.

On the other hand, in a case where metal is not attached (step S160, NO), control unit 10 acquires the detection result of flip-up detector 70 and determines whether or not document P flips up and whether or not the stapling process is applied to document P (step S180). As a result of the determination, in a case where document P flips up (step S180, YES), the process proceeds to step S260.

On the other hand, in a case where document P does not flip up (step S180, NO), control unit 10 acquires the detection result of abnormal sound detector 80 and determines whether or not the abnormal sound occurs and whether or not the stapling process is applied (step S200). As a result of the determination, in a case where the abnormal sound occurs (step S200, YES), the process proceeds to step S260.

On the other hand, in a case where the abnormal sound does not occur (step S200, NO), control unit 10 acquires the detection result of double feeding detector 100 and determines whether or not double-feeding of documents P generates and whether or not the stapling process is applied (step S220). As a result of the determination, in a case where the double-feeding of document P generates (step S220, YES), the process proceeds to step S260.

On the other hand, in a case where the double-feeding of document P does not generate (step S220, NO), control unit 10 determines whether or not an image reading operation of image reader 30 with respect to all documents P loaded on document loading platform 120 is completed (step S240). As a result of the determination, in a case where the image reading operation is not completed (step S240, NO), the process proceeds to step S160. On the other hand, in a case where the image reading operation is completed (step S240, YES), image reading device 1 completes the process in FIG. 12.

As described above in detail, in the embodiment, image reading device 1 includes the document delivery unit (separation and retard rollers 62 and 63) that delivers document P loaded on document loading platform 120 to document transport path 68; flip-up detector 70 that detects the flip-up of document P when document P is delivered by the document delivery unit; metal detector 90 that detects the metal attached to document P when document P is delivered by the document delivery unit; abnormal sound detector 80 that detects occurrence of the abnormal sound when document P is delivered by the document delivery unit; double feeding detector 100 that detects the double-feeding of documents P when document P is delivered by the document delivery unit; and the staple determination unit (CPU 12) that determines whether or not the stapling process is applied to document P based on the detection results of flip-up detector 70, metal detector 90, abnormal sound detector 80, and double feeding detector 100.

According to the embodiment having such a configuration, even if the position to which the stapling process is applied varies in document P, it is possible to detect that the stapling process is applied to document P by at least one of flip-up detector 70, metal detector 90, abnormal sound detector 80, and double feeding detector 100. As a result, it is possible to accurately determine presence or absence of the stapling process and in a case where it is determined that the stapling process is applied to document P, the transport operation of document P can be early stopped. Therefore, it is possible to prevent occurrence of a problem which is generated in a case where document P to which the stapling process is applied is transported through document transport path 68, more specifically, a problem that document P itself is torn or transport roller pairs 64 to 66 and image reader 30 disposed on document transport path 68 are broken.

In the embodiment, an example, in which it is determined whether or not the stapling process is applied to document P based on the detection results of flip-up detector 70, metal detector 90, abnormal sound detector 80, and double feeding detector 100, is described, but the example is not limited to the embodiment. For example, it may be determined whether or not the stapling process is applied to document P based on the detection results of flip-up detector 70 and metal detector 90.

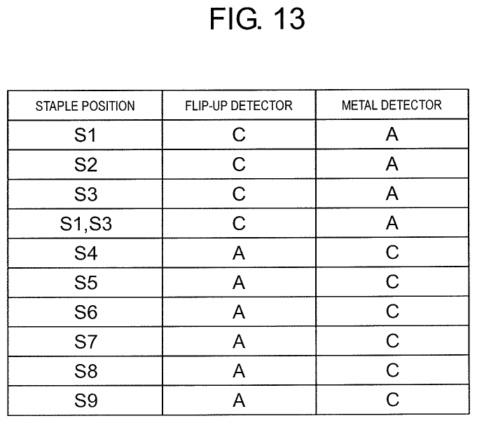

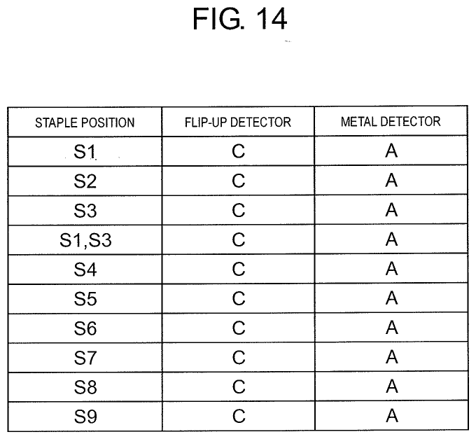

FIGS. 13 and 14 are views illustrating a relationship between each of positions S1 to S9 to which the stapling process is applied in document P, and whether or not the stapling process is detected by each of the detectors (flip-up detector 70 and metal detector 90). FIG. 13 illustrates a case where as the stapling process, a process of stitching the plurality of documents P of binding objects is applied using the staple needle made of metal to bind the plurality of documents P with the staple needle itself. FIG. 14 illustrates a case where as the stapling process, a process of stitching one document P is applied using the staple needle made of metal.

In FIGS. 13 and 14, “A” indicates that the stapling process can be detected before the position to which the stapling process is applied passes through separation roller 62 and retard roller 63, that is, the stapling process is early detected. In addition, “C” indicates that document P itself is torn or transport roller pairs 64 to 66 and image reader 30 disposed on document transport path 68 are broken regardless of whether or not the stapling process is detected by each of the detectors (flip-up detector 70 and metal detector 90) is provided.

As illustrated in FIGS. 13 and 14, even if the position to which the stapling process is applied varies in document P, it is possible to accurately determine presence or absence of the stapling process with respect to document P by fewer detectors.

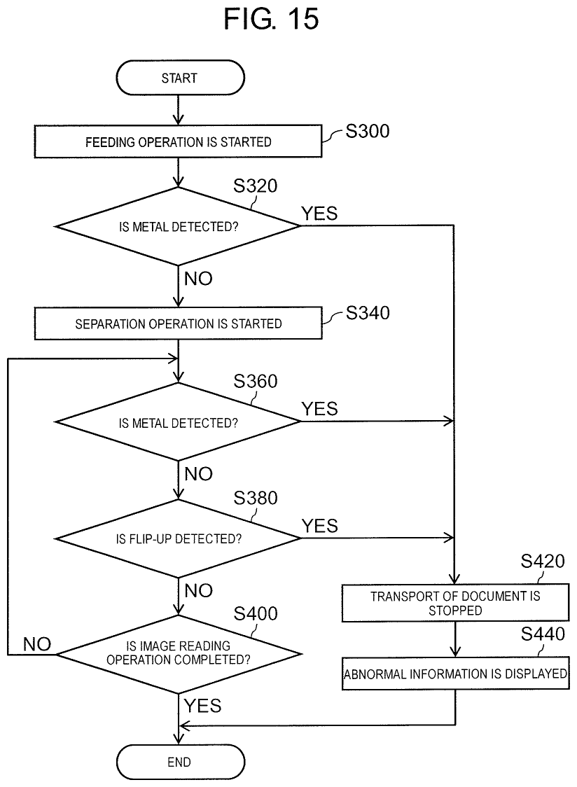

FIG. 15 is a flowchart illustrating a staple determining operation of image reading device 1 in a case where flip-up detector 70 and metal detector 90 are used. A process of step S300 in FIG. 15 is started when power supply of image reading device 1 is turned on and document P is loaded on document loading platform 120.

First, control unit 10 controls transport unit 60 (paper feeding roller 61) and starts a feeding operation of document P loaded on document loading platform 120 (step S300). Next, control unit 10 acquires a detection result of metal detector 90 and determines whether or not metal is attached to document P and whether or not the stapling process is applied to document P (step S320). As a result of the determination, in a case where the metal is attached (step S320, YES), control unit 10 controls transport unit 60 so as to stop the transport of document P (step S420).

Next, control unit 10 causes information display unit 24 to display abnormal information, more specifically, information indicating the fact that the stapling process is applied to document P (step S440). Upon completion of the process of step S440, image reading device 1 completes the process in FIG. 15.

Returning to the determination of step S320, in a case where metal is not attached (step S320, NO), control unit 10 controls transport unit 60 (separation roller 62 and retard roller 63) and starts a separation operation of documents P drawn into between separation roller 62 and retard roller 63 by paper feeding roller 61 (step S340).

Next, control unit 10 acquires a detection result of metal detector 90 and determines whether or not metal is attached to document P and whether or not the stapling process is applied to document P (step S360). As a result of the determination, in a case where the metal is attached (step S360, YES), the process proceeds to step S420.

On the other hand, in a case where metal is not attached (step S360, NO), control unit 10 acquires the detection result of flip-up detector 70 and determines whether or not document P flips up and whether or not the stapling process is applied to document P (step S380). As a result of the determination, in a case where document P flips up (step S380, YES), the process proceeds to step S420.

On the other hand, in a case where document P does not flip up (step S380, NO), control unit 10 determines whether or not the image reading operation of image reader 30 is completed with respect to all documents P loaded on document loading platform 120 (step S400). As a result of the determination, in a case where the image reading operation is not completed (step S400, NO), the process proceeds to step S360. On the other hand, in a case where the image reading operation is completed (step S400, YES), image reading device 1 completes the process in FIG. 15.

It is not determined whether or not the stapling process is applied to document P based on the detection results of flip-up detector 70, metal detector 90, abnormal sound detector 80, and double feeding detector 100, and it may be determined whether or not the stapling process is applied to document P based on the detection results of flip-up detector 70, abnormal sound detector 80, and double feeding detector 100.

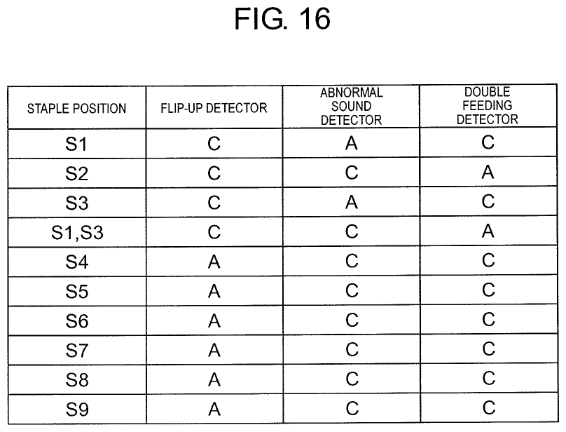

FIG. 16 is a view illustrating a relationship between each of positions S1 to S9 to which the stapling process is applied in document P, and whether or not the stapling process is detected by each of the detectors (flip-up detector 70, abnormal sound detector 80, and double feeding detector 100). FIG. 16 illustrates a case where as the stapling process, a process of stitching the plurality of documents P of binding objects is applied using the staple needle to bind the plurality of documents P by the staple needle itself, or a process of crimping and binding the plurality of documents P without stitching the plurality of documents P as the binding targets is applied using the staple needle.

In FIG. 16, “A” indicates that the stapling process can be detected before the position to which the stapling process is applied passes through first transport roller pair 64. In addition, “C” indicates that document P itself is torn or transport roller pairs 64 to 66 and image reader 30 disposed on document transport path 68 are broken regardless of whether or not the stapling process is detected by each of detectors (flip-up detector 70, abnormal sound detector 80, and double feeding detector 100).

As illustrated in FIG. 16, even if the position to which the stapling process is applied varies in document P, it is possible to accurately determine presence or absence of the stapling process with respect to document P. However, from the viewpoint of more reliably preventing breakage of document P, transport roller pairs 64 to 66, and image reader 30, it is preferable that the stapling process is detected before the position to which the stapling process is applied passes through separation roller 62 and retard roller 63, that is, the stapling process is early detected, and it is preferable that it is determined whether or not the stapling process is applied to document P based on the detection results of flip-up detector 70, metal detector 90, abnormal sound detector 80, and double feeding detector 100.

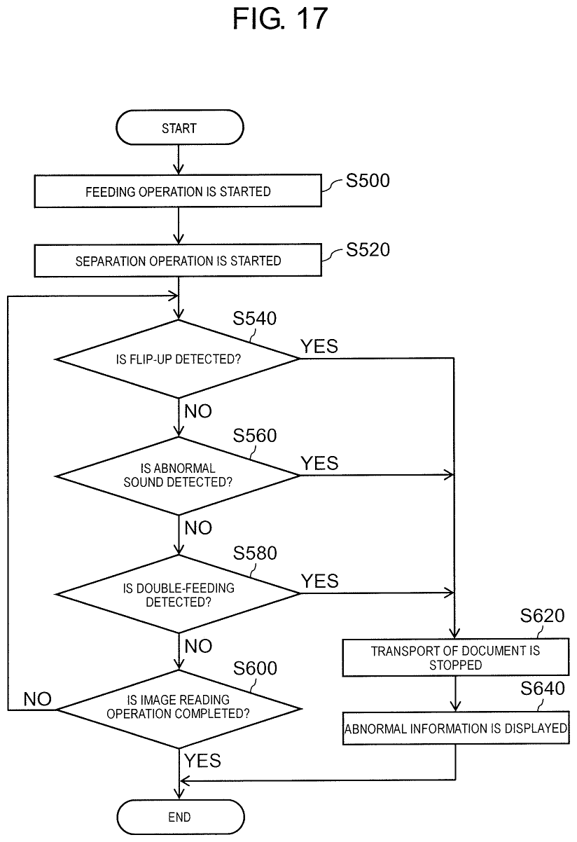

FIG. 17 is a flowchart illustrating a staple determining operation of image reading device 1 using flip-up detector 70, abnormal sound detector 80, and double feeding detector 100. A process of step S500 in FIG. 17 is started when power supply of image reading device 1 is turned on and document P is loaded on document loading platform 120.

First, control unit 10 controls transport unit 60 (paper feeding roller 61) and starts a feeding operation of document P loaded on document loading platform 120 (step S500). Next, control unit 10 controls transport unit 60 (separation roller 62 and retard roller 63) and starts a separation operation of documents P drawn into between separation roller 62 and retard roller 63 by paper feeding roller 61 (step S520).

Next, control unit 10 acquires the detection result of flip-up detector 70 and determines whether or not document P flips up and whether or not the stapling process is applied to document P (step S540). As a result of the determination, in a case where document P flips up (step S540, YES), control unit 10 controls transport unit 60 so as to stop the transport of document P (step S620).

Next, control unit 10 causes information display unit 24 to display abnormal information, more specifically, information indicating the fact that the stapling process is applied to document P (step S640). The process of step S640 is completed, so that image reading device 1 completes the process in FIG. 17.

Returning to the determination of step S540, in a case where document P does not flip up (step S540, NO), control unit 10 acquires the detection result of abnormal sound detector 80 and determines whether or not the abnormal sound occurs and whether or not the stapling process is applied (step S560). As a result of the determination, in a case where the abnormal sound occurs (step S560, YES), the process proceeds to step S620.

On the other hand, in a case where the abnormal sound does not occur (step S560, NO), control unit 10 acquires the detection result of double feeding detector 100 and determines whether or not double-feeding of documents P generates and whether or not the stapling process is applied (step S580). As a result of the determination, in a case where the double-feeding of document P generates (step S580, YES), the process proceeds to step S620.

On the other hand, in a case where the double-feeding of document P does not generate (step S580, NO), control unit 10 determines whether or not an image reading operation of image reader 30 with respect to all documents P loaded on document loading platform 120 is completed (step S600). As a result of the determination, in a case where the image reading operation is not completed (step S600, NO), the process proceeds to step S540. On the other hand, in a case where the image reading operation is completed (step S600, YES), image reading device 1 completes the process in FIG. 17.

In addition, all of the above-described embodiments merely illustrate an example of a concrete implementation in implementing this disclosure, and the technical scope of this disclosure should not be interpreted restrictively by them. That is, this disclosure can be implemented in various forms without departing from the gist or the main features thereof.

### INDUSTRIAL APPLICABILITY

This disclosure is useful as an image reading device and a staple determination method capable of accurately determining the presence or absence of a stapling process.

REFERENCE MARKS IN THE DRAWINGS

1 IMAGE READING DEVICE

10 CONTROL UNIT

12 CPU

14 ROM

16 RAM

20 OPERATION DISPLAY UNIT

22 OPERATION INFORMATION INPUT UNIT

24 INFORMATION DISPLAY UNIT

30 IMAGE READER

40 AUXILIARY STORAGE UNIT

50 NETWORK CONNECTION UNIT

60 TRANSPORT UNIT

61 PAPER FEEDING ROLLER

62 SEPARATION ROLLER

63 RETARD ROLLER

64 FIRST TRANSPORT ROLLER PAIR

65 SECOND TRANSPORT ROLLER PAIR

66 THIRD TRANSPORT ROLLER PAIR

68 DOCUMENT TRANSPORT PATH

70 FLIP-UP DETECTOR

80 ABNORMAL SOUND DETECTOR

90 METAL DETECTOR

100 DOUBLE FEEDING DETECTOR

110 INCLINATION DETECTOR

120 DOCUMENT LOADING PLATFORM

130 DOCUMENT DISCHARGING UNIT

P DOCUMENT

1. An image reading device which transports a document loaded on a document loading platform to a document transport path and reads an image formed on the document, the device comprising:
a document delivery unit for delivering the document loaded on the document loading platform to the document transport path;
a flip-up detector for detecting flip-up of the document when the document is delivered by the document delivery unit;
an abnormal sound detector for detecting occurrence of abnormal sound when the document is delivered by the document delivery unit;
a double feeding detector for detecting double-feeding of the document when the document is delivered by the document delivery unit; and
a staple determination unit for determining whether or not a stapling process is applied to the document based on detection results of the flip-up detector, the abnormal sound detector, and the double feeding detector.

2. The image reading device of claim 1,
wherein the staple determination unit determines whether or not the stapling process is applied to the document based on at least one of detection results of the abnormal sound detector and the double feeding detector.

3. The image reading device of claim 1, further comprising:
a transport controller for performing control to stop a transport operation of the document in a case where it is determined that the stapling process is applied by the staple determination unit.

4. The image reading device of claim 1, further comprising:
an inclination detector for detecting an inclination of the document when the document is delivered by the document delivery unit,
wherein the staple determination unit determines whether or not the stapling process is applied to the document based on detection results of the flip-up detector, the abnormal sound detector, the double feeding detector, and the inclination detector.

5. The image reading device of claim 1,
wherein the double feeding detector is disposed on a downstream side of the document delivery unit in a document transporting direction.

6. The image reading device of claim 1, further comprising:
an image reader disposed on a downstream side of the flip-up detector, the abnormal sound detector, and the double feeding detector in a document transporting direction, and reading an image formed on the document.

7. The image reading device of claim 1, further comprising:
a metal detector for detecting metal attached to the document when the document is delivered by the document delivery unit,
wherein the staple determination unit determines whether or not the stapling process is applied to the document based on detection results of the flip-up detector, the metal detector, the abnormal sound detector, and the double feeding detector.

8. The image reading device of claim 7,
wherein the staple determination unit determines whether or not the stapling process is applied to the document based on at least one of detection results of the flip-up detector, the metal detector, the abnormal sound detector, and the double feeding detector.

9. The image reading device of claim 7, further comprising:
a transport controller for performing control to stop the transport operation of the document in a case where it is determined that the stapling process is applied by the staple determination unit.

10. The image reading device of claim 7, further comprising:
an inclination detector for detecting an inclination of the document when the document is delivered by the document delivery unit,
wherein the staple determination unit determines whether or not the stapling process is applied to the document based on detection results of the flip-up detector, the metal detector, the abnormal sound detector, the double feeding detector, and the inclination detector.

11. The image reading device of claim 7,
wherein the metal detector is disposed on an upstream side of the document delivery unit in the document transporting direction.

12. The image reading device of claim 7,
wherein the double feeding detector is disposed on the downstream side of the document delivery unit in the document transporting direction.

13. The image reading device of claim 7, further comprising:
an image reader disposed on a downstream side of the flip-up detector, a metal detector, the abnormal sound detector, and the double feeding detector in the document transporting direction, and reading an image formed on the document.

14. A staple determination method comprising:
acquiring a detection result of a flip-up detector that detects flip-up of a document when the document loaded on a document loading platform is delivered to a document transport path;
acquiring a detection result of an abnormal sound detector that detects occurrence of abnormal sound when the document is delivered;
acquiring a detection result of a double feeding detector that detects double-feeding of the document when the document is delivered; and
determining whether or not a stapling process is applied to the document based on detection results of the flip-up detector, the abnormal sound detector, and the double feeding detector.

15. The staple determination method of claim 14, further comprising:
acquiring a detection result of the metal detector that detects metal attached to the document when the document is delivered; and
determining whether or not the stapling process is applied to the document based on detection results of the flip-up detector, the metal detector, the abnormal sound detector, and the double feeding detector.
